(19) United States
(12) Patent Application Publication
(10) Pub. No.: US 2025/0005105 A1
(43) Pub. Date: Jan. 2, 2025

(54) ANALYSIS EVALUATION SUPPORT APPARATUS, ANALYSIS EVALUATION SUPPORT METHOD, AND PROGRAM

(71) Applicant: NEC Corporation, Tokyo (JP)

(72) Inventor: Yuki ASHINO, Tokyo (JP)

(73) Assignee: NEC Corporation, Tokyo (JP)

(21) Appl. No.: 18/751,390

(22) Filed: Jun. 24, 2024

(30) Foreign Application Priority Data
Jun. 27, 2023 (JP) 2023-1050028

(51) Int. Cl. G06F 17/17

(52) U.S. Cl. CPC G06F 17/17

(57) ABSTRACT

An analysis evaluation support apparatus includes: a first evaluation value calculation part that calculates a first evaluation value on a basis of a change in an amount of analysis target data caused by an analysis function; a second evaluation value calculation part that calculates a second evaluation value representing an evaluation of the analysis function by a person who uses the analysis function; and an output part that outputs support data obtained from at least one of the first evaluation value and the second evaluation value.

### REFERENCE TO RELATED APPLICATION

The present invention is based upon and claims the benefit of the priority of Japanese patent application No. 2023-105028 filed on Jun. 27, 2023, the disclosure of which is incorporated herein in its entirety by reference thereto.

### FIELD

The present invention relates to an analysis evaluation support apparatus, analysis evaluation support method, and program.

### BACKGROUND

There is a large amount of data that has been collected and accumulated but is not being effectively utilized. There is a growing need for “analysis” to extract valuable information from such data. Since the specialized technical experts who are familiar with data analysis methods (developers) differ from the experts in each field (users), a system is needed to evaluate the analysis methods developed by the developers.

There is a technique for evaluating analysis procedures on the basis of a plurality of characteristics of data analysis in order to select an appropriate analysis procedure according to attributes of an analysis target (for example, refer to Patent Literature (PTL) 1). The technique disclosed in PTL 1 determines an index for selection of an analysis procedure on the basis of attributes of an analysis target and selects from a plurality of analysis procedures an analysis procedure in which an evaluation value of a property of data analysis satisfies a preset condition in connection with the index.

[PTL 1] International Publication Number WO2019/187012

### SUMMARY

The following analysis is given by the present invention.

In the PTL 1, the characteristics of data analysis listed are analysis speed, analysis accuracy, and analysis robustness. In the technique disclosed in PTL 1, these are calculated using training data rather than actual diagnosed data. However, analysis speed and robustness are affected by factors other than the analysis function, so it is difficult to say that they are evaluations of the analysis method itself. Analysis accuracy is only applicable to special analyses where the true value is clear and is not versatile.

In addition, since the purpose of the technology disclosed in PTL 1 is to select an appropriate analysis method, it is an evaluation before starting an analysis using said analysis method and does not include an evaluation by experts in the field who have actually used the analysis method.

Therefore, it is insufficient to quantitatively evaluate the value, such as the effectiveness and usefulness of the analytical method. Therefore, it does not help in determining policy for improvement of analytical methods once they have been developed and are being used. Under these circumstances, a versatile, multifaceted, multidimensional, and quantitative evaluation of analysis methods developed by developers who are not experts in the field of accumulated data is desired.

In view of the circumstances described above, it is an object of the present invention to provide a technique that is versatile, multifaceted, multidimensional, and supports quantitative evaluation in the evaluation of analytical methods.

According to a first aspect of the present invention, an analysis evaluation support apparatus, including:
a first evaluation value calculation part that calculates a first evaluation value on a basis of a change in an amount of analysis target data caused by an analysis function;
a second evaluation value calculation part that calculates a second evaluation value that represents an evaluation of the analysis function by a person who uses the analysis function; and
an output part that outputs support data obtained from at least one of the first evaluation value and the second evaluation value.

According to a second aspect of the present invention,
an analysis evaluation support method executed by a computer of an analysis evaluation support apparatus, the analysis evaluation support method including:
calculating a first evaluation value on a basis of a change in an amount of processing target data caused by an analysis function;
calculating a second evaluation value representing an evaluation of the analysis function by a person who uses the analysis function; and
outputting support data obtained from at least one of the first evaluation value and the second evaluation value.

According to a third aspect of the present invention, a program causes a computer of an analysis evaluation support apparatus to execute:
processing of calculating a first evaluation value on a basis of a change in an amount of processing target data caused by an analysis function;
processing of calculating a second evaluation value representing an evaluation of the analysis function by a person who uses the analysis function; and
processing of outputting support data obtained from at least one of the first evaluation value and the second evaluation value.

Moreover, the program causes the computer to execute outputting support data obtained from at least one of the first evaluation value and the second evaluation value.

Further, these programs can be recorded on a computer-readable storage medium. The storage medium may be a non-transitory one such as a semiconductor memory, a hard disk, a magnetic recording medium, an optical recording medium, and the like. The present invention can also be realized as a computer program product.

According to the present invention, it becomes possible to support multifaceted, multidimensional, and quantitative evaluation with high versatility in the evaluation of an analysis method.

### BRIEF DESCRIPTION OF DRAWINGS

FIGS. 1A and 1B are drawings illustrating examples of functional block and hardware configurations, respectively, of an analysis evaluation support apparatus of an example embodiment of the present invention.

FIGS. 2A to 2C are drawings illustrating examples of the configuration of an analysis function evaluation system, functional blocks of an analysis apparatus, and functional blocks of an analysis evaluation support apparatus, respectively, of an example embodiment of the present invention.

FIGS. 3A and 3B are drawings for explaining examples of analysis target data and an analysis function list, respectively, of an example embodiment of the present invention.

FIGS. 4A to 4C are drawings for explaining examples of the outputs from analysis functions of an example embodiment of the present invention, and FIG. 4D is a drawing for explaining examples of first evaluation values of an example embodiment of the present invention.

FIGS. 5A to 5C are drawings for explaining examples of second evaluation values, overall evaluation values, and evaluation values stored in an evaluation value storage part, respectively, of an example embodiment of the present invention.

FIGS. 6A and 6B are other drawings describing examples of output screens of an example embodiment of the present invention.

FIG. 7 is a flowchart of an analysis evaluation support process of an example embodiment of the present invention.

FIGS. 8A to 8C are drawings illustrating examples of the configuration of an analysis function evaluation system, functional blocks of an analysis apparatus, and functional blocks of an analysis evaluation support apparatus, respectively, of an example embodiment of the present invention.

FIG. 9 is another drawing describing an example of an output screen of an example embodiment of the present invention.

FIG. 10 is a flowchart of an analysis evaluation support process of an example embodiment of the present invention.

FIGS. 11A to 11C are drawings illustrating examples of functional blocks, proposal policies, and an output screen of an analysis evaluation support apparatus, respectively, of an example embodiment of the present invention.

FIG. 12 is a drawing illustrating an example of an overall configuration of an analysis function evaluation system of an example embodiment of the present invention.

FIGS. 13A to 13D are drawings for explaining examples of evaluation values stored in an evaluation value storage part of an example embodiment of the present invention.

FIGS. 14A to 14C are drawings for explaining examples of proposal policies and output screens, respectively, of an example embodiment of the present invention.

### EXAMPLE EMBODIMENTS

The following describes an outline of an example embodiment of the present invention (referred to as the present example embodiment hereinafter) with reference to the drawings. It should be noted that the drawing reference signs are given to each element for convenience as an example to facilitate understanding and are not intended to limit the present invention to the illustrated aspects. Further, connection lines between blocks in the drawings referred to in the following description can be both bidirectional and unidirectional. A unidirectional arrow schematically shows the main flow of a signal (data) and does not exclude bidirectionality.

Although the input/output connection points of each block in the drawings have ports or interfaces, these are not illustrated. Further, in the following description, “A and/or B” means A or B, or A and B.

### First Example Embodiment

The following describes an example embodiment (first example embodiment) of the present invention with reference to the drawings.

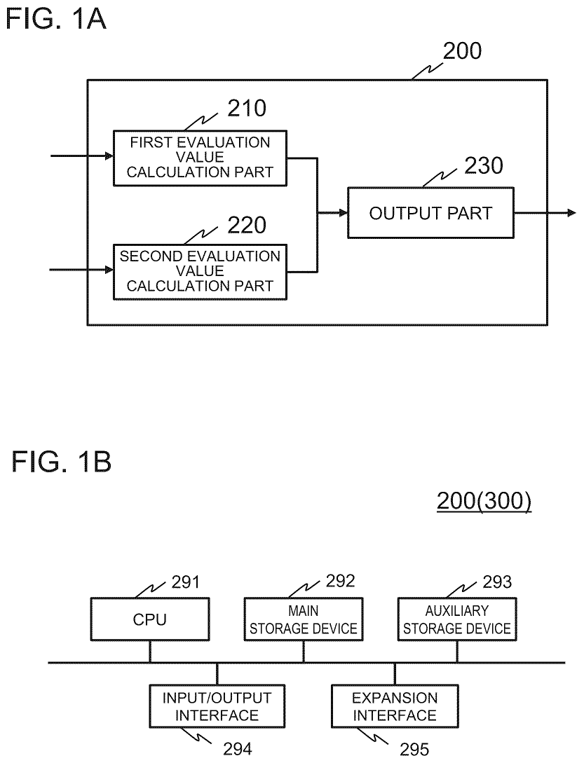

FIG. 1A is a functional block diagram of an analysis evaluation support apparatus 200 of the present example embodiment. The analysis evaluation support apparatus 200 of the present example embodiment calculates support data that assists the evaluation of various analysis functions executed by an external analysis apparatus to provide the support data to a user. The analysis executed by an analysis function is a process of extracting the necessary data for a predetermined decision-making process from a predetermined dataset.

Note that the users herein include a person who uses an analysis function and a developer who develops an analysis function.

The analysis evaluation support apparatus 200 of the present example embodiment provides users with support data that enables multifaceted, multidimensional evaluation of various analysis functions. The support data provided includes a first evaluation value and a second evaluation value. The first evaluation value objectively evaluates the performance, etc. of an analysis function itself. The second evaluation value represents a subjective evaluation based on the actual use of the analysis function by the person who uses thereof.

In the present example embodiment, the first evaluation value is a value that evaluates the analysis function on a basis of changes in the amount of data to be analyzed (analysis target data). Concretely, the first evaluation value is a value that indicates how much the amount of data is reduced (degree of reduction) for analysis target data by an analysis function to be evaluated. In the present example embodiment, the second evaluation value is the number of times the analysis function to be evaluated is used.

In order to achieve the above, the analysis evaluation support apparatus 200 of the present example embodiment includes a first evaluation value calculation part 210, a second evaluation value calculation part 220, and an output part 230, as illustrated in FIG. 1A.

The first evaluation value calculation part 210 calculates, for each analysis function to be evaluated, the first evaluation value on the basis of a change in the amount of the analysis target data caused by the analysis function thereof. As mentioned above, the first evaluation value indicates the degree of reduction for the amount of data by the analysis function.

It should be noted that the first evaluation value is an evaluation value based on the concept of information thermodynamics, which deals with the value of information focusing on entropy used in thermodynamics. For example, information thermodynamics is discussed by Takahiro Sagawa in his paper “Thermodynamics of Information Processing” dated May 8, 2014 (Bussei Kenkyu @ Web, Vol. 4, No. 1, 041209, February 2015). In other words, the first evaluation value is an evaluation value that focuses on extracting a value to be extracted more efficiently from the data set that contains the value to be extracted. That is to say, the first evaluation value is a value based on an evaluation method that evaluates the analysis function according to how much data other than the value to be extracted could be removed.

According to information thermodynamics, the more unnecessary data is removed from the collected data, the more value is considered to have been extracted. This is because the collected data has a high entropy, indicating a state of randomness, and by removing unnecessary data therefrom, the entropy decreases, leading to an increase in value.

The second evaluation value calculation part 220 calculates, for each analysis function, the second evaluation value that represents an evaluation of the analysis function by a person who uses thereof. In the present example embodiment, the second evaluation value is calculated as the number of times the analysis function is used. This is an evaluation value based on the concept that analytical functions that are more useful and/or easier for a person who uses thereof to use will be used more often.

The output part 230 externally outputs the support data (output information) obtained from at least one of the first evaluation value and the second evaluation value. For example, the output part 230 may output each evaluation values (the first evaluation value and/or the second evaluation value) themselves as support data to a display or other device that can be viewed by the user.

As described above, according to the present example embodiment, a person who actually uses analysis functions and/or a developer who develops analysis functions can obtain evaluation values evaluated on multiple different evaluation axes for each analysis function. Concretely, the user obtains the degree of data reduction, which indicates the performance of the analysis function itself, and the number of uses, which indicates a subjective evaluation based on the actual use by the person who uses thereof. Thus, the user can perceive each analysis function as multifaceted and multidimensional based on these objectives, versatile, and an evaluation values that also take into account an evaluation by a person who actually uses thereof.

For example, by looking at the second evaluation value, which indicates the number of times used, the person who uses thereof can understand which analytical functions are easier to use and/or more effective. By looking at the degree of reduction in the amount of data and the number of times used, the developer can not only understand the analysis that is important for a current operation of the person who uses thereof, but also whether or not improvements are needed. This allows the developer to consider an appropriate improvement plan for the current analysis function. Furthermore, the developer can present the basis for such improvement to a person who uses thereof.

### Second Example Embodiment

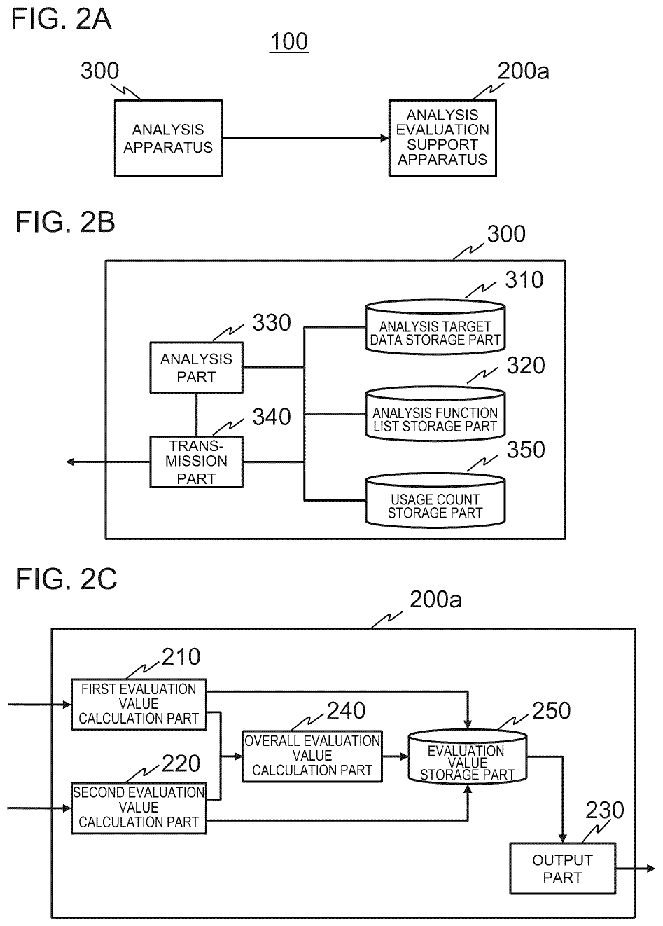

Next, a second example embodiment of the present invention will be described. In the present example embodiment, an overall evaluation value is further calculated from the first and the second evaluation values. FIG. 2A is a drawing illustrating an example of the system configuration of an analysis function evaluation system 100 of the present example embodiment. As illustrated in the drawing, the analysis function evaluation system 100 is provided with an analysis apparatus 300 and an analysis evaluation support apparatus 200a that can transmit and receive data to and from the analysis apparatus 300.

The analysis apparatus 300 is provided with at least one analysis function and transmits predetermined analysis-related information (data) for analysis to the analysis evaluation support apparatus 200a. For example, the analysis-related information to be transmitted includes the number of data (analysis target data) used by an analysis function, an analysis function list, the number of times the analysis function is used, etc.

In order to achieve this, the analysis apparatus 300 of the present example embodiment is provided with an analysis target data storage part 310, an analysis function list storage part 320, an analysis part 330, a transmission part 340, and a usage count storage part 350, as illustrated in FIG. 2B.

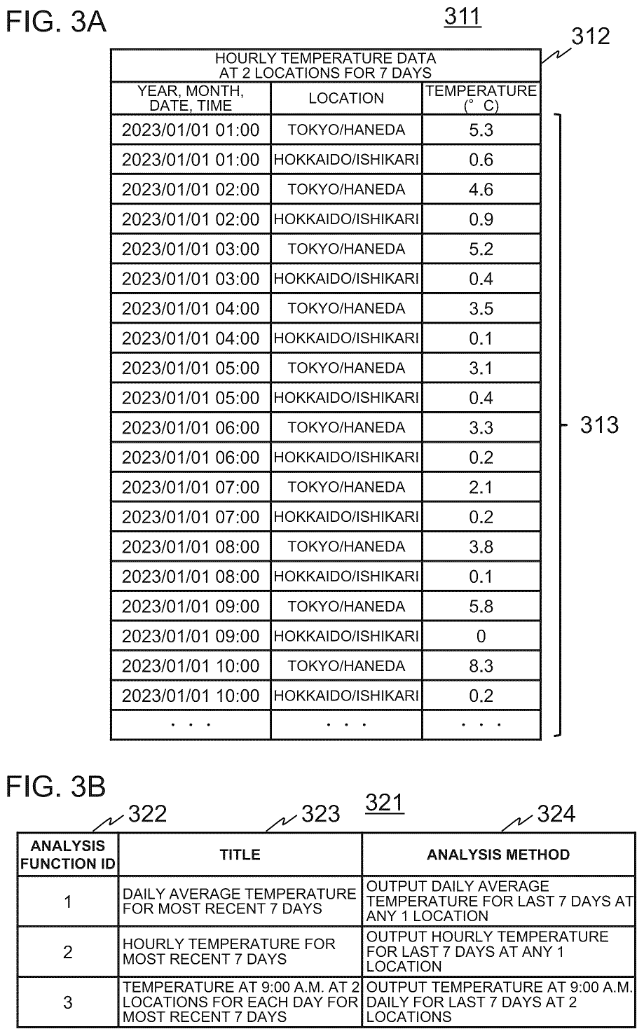

The analysis target data storage part 310 stores analysis target data 311, which is the data to be analyzed. FIG. 3A illustrates an example of the analysis target data 311 stored in the analysis target data storage part 310.

As illustrated in the drawing, the analysis target data 311 is provided with, for example, attribute information 312 and data body 313. For example, the attribute information 312 includes information that enables the analysis evaluation support apparatus 200a to calculate the amount of data reduction by an analysis function for the data to be analyzed, as described below. Here, the information identifying the data to be stored as the analysis target data 311, i.e., “hourly temperature data at two locations for seven days.” is stored for the attribute information 312. The attribute information 312 may be, for example, a total number of data or a total number of data items in the analysis target data 311 stored.

The analysis function list storage part 320 stores a list of analysis functions (analysis function list 321) to be executed by the analysis part 330. FIG. 3B illustrates an example of the analysis function list 321 stored in the analysis function list storage part 320.

As illustrated in the drawing, the analysis function list 321 is provided with an analysis function ID 322, a title 323, and an analysis method 324.

The analysis function ID 322 is identification information that uniquely identifies each analysis function and is automatically assigned each time a new analysis function is created and registered. The title 323 is the title of an analysis function and is named and given, for example, by the developer of the analysis function. The analysis method 324 is the processing content of an analysis function, and for example, is registered by the developer of the analysis function. The analysis evaluation support apparatus 200a, described below, interprets the analysis method 324 of the analysis function list 321 and calculates the first evaluation value, etc.

The usage count storage part 350 stores the number of times each analysis function is used. The number of times used (usage count) is registered, for example, by the analysis part 330.

The analysis part 330 executes an analysis function stored in the analysis function list storage part 320 according to an instruction instructed by a person who uses thereof. For example, when receiving an instruction to execute a specific analysis function from the person, the analysis part 330 executes the specific analysis function. In the present example embodiment, for each execution, the analysis part 330 counts the number of executions and stores it as the number of times used in the usage count storage part 350.

The transmission part 340 transmits predetermined information to the analysis evaluation support apparatus 200a at a predetermined timing. In the present example embodiment, the transmission part 340 transmits the attribute information 312 stored in the analysis target data storage part 310, the analysis function list 321 stored in the analysis function list storage part 320, and the number of times used stored in the usage count storage part 350.

The transmission part 340 may, for example, transmit the various information described above upon receiving a request from the analysis evaluation support apparatus 200a. The transmission part 340 may transmit the attribute information 312 each time the analysis target data 311 is updated. Similarly, the transmission part 340 may transmit the analysis function list 321 each time the analysis function list 321 is updated.

The analysis evaluation support apparatus 200a calculates the support data that assists in evaluation of each analysis function executed by the analysis apparatus 300 and provides thereof to the user. The analysis evaluation support apparatus 200a of the present example embodiment has basically the same functions as those of the analysis evaluation support apparatus 200 of the first example embodiment. However, the analysis evaluation support apparatus 200a of the present example embodiment further calculates the overall evaluation value from the first and the second evaluation values.

As illustrated in FIG. 2C, the analysis evaluation support apparatus 200a of the present example embodiment is provided with a first evaluation value calculation part 210, a second evaluation value calculation part 220, and an output part 230. In addition, the analysis evaluation support apparatus 200a of the present example embodiment is further provided with an overall evaluation value calculation part 240 and an evaluation value storage part 250.

The evaluation value storage part 250 stores each calculation result of the first evaluation value calculation part 210, the second evaluation value calculation part 220, and the overall evaluation value calculation part 240.

The first evaluation value calculation part 210 performs basically the same processing as that of the functional part of the same name in the analysis evaluation support apparatus 200 of the first example embodiment. In the present example embodiment, the first evaluation value calculation part 210 calculates the first evaluation value, as described below, using the attribute information 312 received from the analysis apparatus 300 and an analysis method 324 on the analysis function list 321. The first evaluation value calculated is stored in the evaluation value storage part 250 in association with information identifying the analysis function (for example, the analysis function ID 322).

As described above, the first evaluation value indicates how much the amount of data is reduced by an analysis function.

The first evaluation value calculation part 210 first calculates the data amount of the analysis target data 311 (pre-analysis data amount) and the data amount after being processed (analyzed) by the analysis function (post-analysis data amount). Then, the first evaluation value calculation part 210 calculates a value obtained by dividing the pre-analysis data amount by the post-analysis data amount, as the first evaluation value. Note that the first evaluation value is set to zero when the post-analysis data amount is zero. The first evaluation value calculation part 210 interprets the attribute information 312 to calculate the pre-analysis data amount. The first evaluation value calculation part 210 interprets, for example, the analysis method 324 on the analysis function list 321 to calculate the post-analysis data amount for each analysis function. In the following, the first evaluation value calculation part 210 uses the number of data items as the amount of data

For example, when “hourly temperature data at two locations for seven days” is stored as the attribute information 312 as described above, the analysis target data 311 includes data for two locations, hourly, for seven days (24×7) for three items identifying date and time, location, and temperature, respectively. In other words, the analysis target data 311 has 2 (locations)×7 (days)×24 (hours)×3 (items; date and time, location, and temperature) (=1,008) data items. From this, the first evaluation value calculation part 210 calculates 1,008 items as the pre-analysis data amount (the number of pre-analysis items).

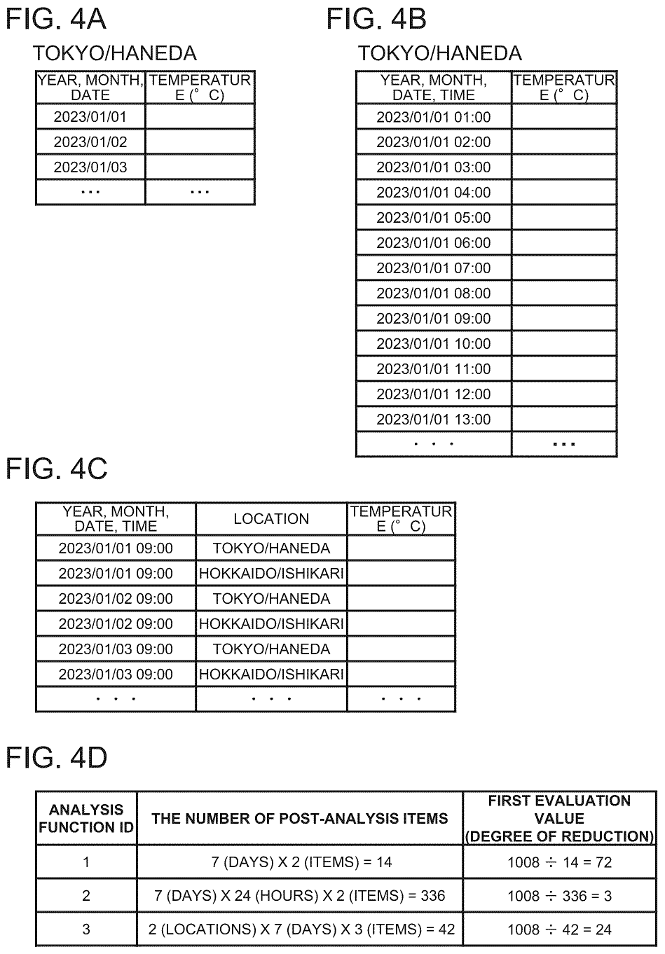

FIGS. 4A to 4C illustrate examples of output after analysis of each analysis function having the analysis function ID 322 of 1 to 3, respectively.

For example, the analysis function having the analysis function ID 322 of 1 is a method that “outputs the daily average temperature for the last seven days at any one location” as described in the analysis method 324. Therefore, as illustrated in FIG. 4D, the number of post-analysis items is 14 (7 days×2 items (date and time, and temperature)). The analysis function having the analysis function ID 322 of 2 is a method that “outputs hourly temperature for the last seven days at any one location.” Therefore, as illustrated in FIG. 4D, the number of post-analysis items is 336 (7 days×24 hours×2 items (date and time, and temperature)). The analysis function having the analysis function ID 322 of 3 is a method that “outputs the temperature at 9:00 a.m. daily for the last seven days at the two locations.” Therefore, as illustrated in FIG. 4D, the number of post-analysis items is 42 (2 locations×7 days×3 items).

The first evaluation value calculation part 210 calculates the numbers of post-analysis items, i.e., 14, 336, and 42 as the post-analysis data amounts for each analysis function.

The first evaluation value calculation part 210 obtains 72, 3, and 24 as the first evaluation value by dividing the number of the pre-analysis items by the number of the post-analysis items, respectively, for each analysis function, as illustrated in FIG. 4D.

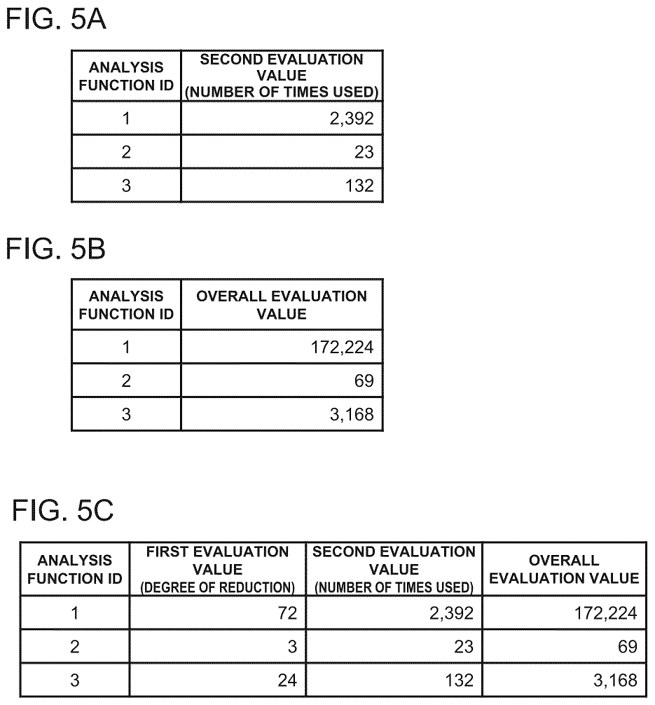

The second evaluation value calculation part 220 performs basically the same processing as that of the functional part of the same name in the analysis evaluation support apparatus 200 of the first example embodiment. As illustrated in FIG. 5A, in the present example embodiment, the second evaluation value calculation part 220 uses the number of times used received from the analysis apparatus 300 as the second evaluation value. The second evaluation value calculated is stored in the evaluation value storage part 250 in association with information identifying the analysis function (for example, the analysis function ID 322).

The overall evaluation value calculation part 240 calculates the overall evaluation value for each analysis function from the first evaluation value and the second evaluation value. In the present example embodiment, the overall evaluation value calculation part 240 calculates a value obtained by multiplying the first evaluation value and the second evaluation value as the overall evaluation value, as illustrated in FIG. 5B. The overall evaluation value is an evaluation value that comprehensively takes into account an aspect of the first evaluation value and an aspect of the second evaluation value for each analytical function. The overall evaluation value calculated is stored in the evaluation value storage part 250 in association with information identifying the analysis function (for example, the analysis function ID 322).

According to the concrete example above, the overall evaluation value calculation part 240 obtains 172,224 (72×2,392), 69 (3×23), and 3,168 (24×132) for each analysis function by multiplying the first evaluation value and the second evaluation value, respectively, as the overall evaluation value.

FIG. 5C illustrates an example of each evaluation value stored in the evaluation value storage part 250 at this point. As illustrated in the drawing, the evaluation value storage part 250 stores the first evaluation value, the second evaluation value, and the overall evaluation value for each analysis function, respectively.

The output part 230 outputs, as the support data, data calculated using at least one of the first evaluation value, the second evaluation value, and the overall evaluation value stored in the evaluation value storage part 250 as an input. In the present example embodiment, the output part 230, for example, arranges required items in a predetermined user interface, and generates them as an output screen, and outputs them. Each user interface is stored in advance in a storage device or the like of the analysis evaluation support apparatus 200a.

The output screen is outputted to a display or other display device. The display may be provided by the analysis evaluation support apparatus 200a or it may be a display provided by the analysis apparatus 300. Alternatively, for example, it may be a pre-registered display of an information processing apparatus that is independent of the analysis apparatus 300 and the analysis evaluation support apparatus 200a and that can transmit and receive data to and from these apparatuses, or it may be a tablet, a smartphone, etc. owned by a person who uses the analysis function or a developer. The same applies to other example embodiments and variations.

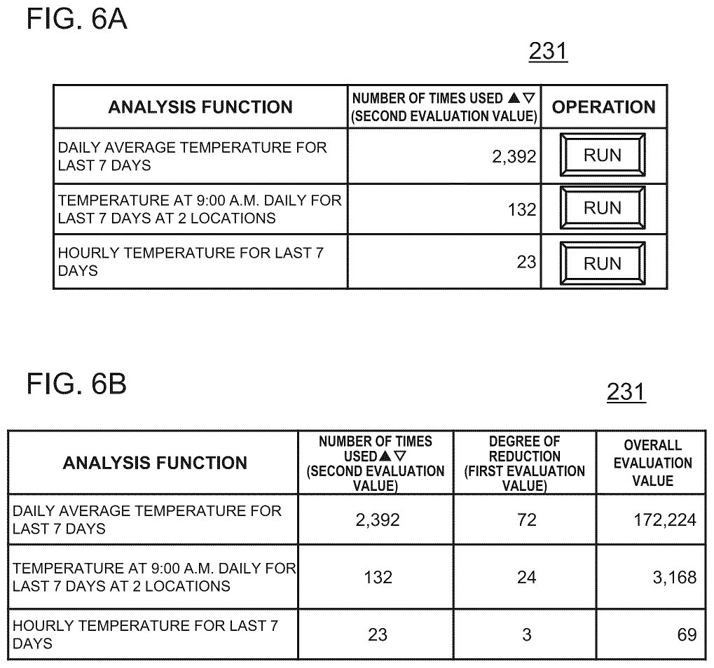

The output part 230 may also select, generate, and output an output screen in response to instructions from the output destination and/or the user. For example, in a user interface for a person who uses an analysis function, the second evaluation value, which indicates the number of times used, is important. Therefore, when receiving an output instruction from the person or outputting the screen to the person's device, the output part 230 outputs, for example, the second evaluation value (number of times used) with the title 323 of each analysis function, as the support data, on an output screen 231, as illustrated in FIG. 6A.

In the example of the output screen 231 illustrated in FIG. 6A, an example that the output screen 231 includes a reception interface that accepts an instruction for executing each analysis function (RUN) is illustrated. In this case, for example, each analysis function may be configured to be sortable in descending or ascending order with respect to the number of times used, rather than in the order of the analysis function ID 322. For example, when selecting an analysis function to use from among a plurality of analysis functions, a person who uses thereof can estimate the high value of the analysis function on a basis of the number of times it has been used in the past, even without knowing the details of the processing of each analysis function.

FIG. 6B illustrates an example of the output screen 231 for developer. When receiving an output instruction from the developer or outputting the screen to the developer's device, the output part 230, for example, outputs all evaluation values calculated as the support data. The developer can look at this and consider the best improvement plan.

### Analysis Evaluation Support Process

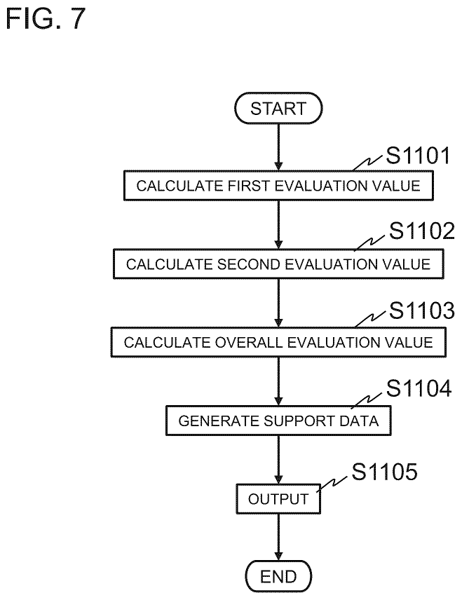

The following describes a flow of the analysis evaluation support process (support data calculation process) performed by the analysis evaluation support apparatus 200a of the present example embodiment. FIG. 7 is the processing flow of the analysis evaluation support process of the present example embodiment. This process is initiated upon receiving an execution instruction from the user.

The first evaluation value calculation part 210 receives the attribute information 312 and the analysis function list 321 from the analysis apparatus 300 and calculates the first evaluation value as described above (step S1101).

The second evaluation value calculation part 220 receives the number of times used from the analysis apparatus 300 and calculates the second evaluation value as described above (step S1102).

The overall evaluation value calculation part 240 calculates the overall evaluation value from the first and the second evaluation values (step S1103).

The output part 230 uses at least one of the first evaluation value, the second evaluation value, and the overall evaluation value to generate the support data (step S1104). Here, for example, the output screen 231 described above is generated as the support data.

The output part 230 outputs the support data generated (step S1105) and terminates the process.

Note that either the first evaluation value calculation process or the second evaluation value calculation process can be executed first. The first evaluation value remains unchanged as long as the analysis function remains unchanged. Therefore, once the first evaluation value is calculated, it may be stored in the evaluation value storage part 250, and thereafter, only the second evaluation value may be calculated as long as the analysis function remains unchanged. The same applies to other example embodiments and variations.

In the processing flow described above, the method is described using a case in which data used as the basis for calculation of evaluation value is acquired from the analysis apparatus 300 when each evaluation value (the first and the second evaluation values and the overall evaluation value) is calculated, as an example. However, the timing of acquiring the data used thereof is not limited thereto. For example, the number of times used may be transmitted from the analysis apparatus 300 to the analysis evaluation support apparatus 200 at a predetermined timing and stored in a storage device, etc., of the analysis evaluation support apparatus 200, and the latest value may be selected therefrom and used when an evaluation value is calculated. The same applies to other example embodiments and variations.

As described above, according to the present example embodiment, the same effects as those of the first example embodiment can be obtained since it has the same configuration as the first example embodiment. Further, in the present example embodiment, the overall evaluation value is calculated from the first and the second evaluation values. As a result, it is possible to obtain an evaluation value integrating both aspects for each analysis function. For example, according to the present example embodiment, even a developer who has no knowledge of the field related to the data to be processed can easily understand a high-performance analysis function that is popular among people who use thereof. Therefore, it is possible to provide useful information for developers to evaluate the analysis functions and determine future development policies.

### Third Example Embodiment

Next, a third example embodiment of the present invention will be described. In the present example embodiment, the processing time for each analysis function is further calculated as a third evaluation value.

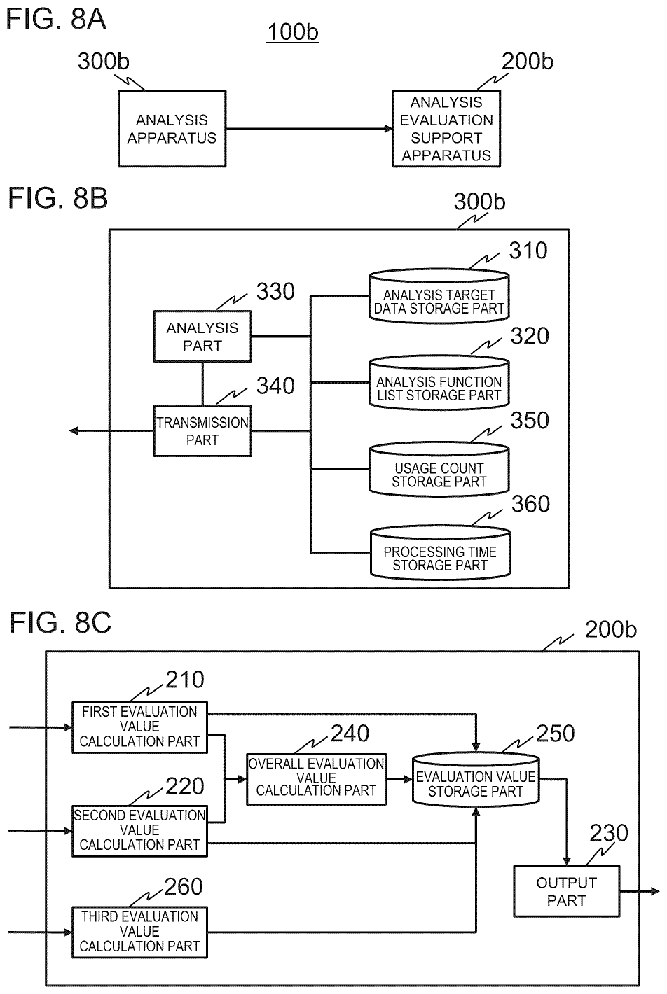

As illustrated in FIG. 8A, an analysis function evaluation system 100b of the present example embodiment is provided with an analysis apparatus 300b and an analysis evaluation support apparatus 200b that can transmit and receive data to and from the analysis apparatus 300b.

As illustrated in FIG. 8B, the analysis apparatus 300b of the present example embodiment basically has the same configuration as that of the analysis apparatus 300 of the second example embodiment. The analysis apparatus 300b of the present example embodiment is further provided with a processing time storage part 360. The analysis part 330 stores the processing time of each analysis function in the processing time storage part 360 each time the analysis function is used. The processing time is, for example, the time from the start of execution of the analysis function until a response is received.

Further, the processing time stored in the processing time storage part 360 may be a single cumulative value that is added each time an analysis function is executed, or it may be an individual processing time (individual value) for each execution. The same applies to other example embodiments and variations.

The transmission part 340 of the present example embodiment transmits the processing time stored in the processing time storage part 360 to the analysis evaluation support apparatus 200b along with other information at a predetermined timing or upon receiving a request from the analysis evaluation support apparatus 200b.

Since the other functional parts of the analysis apparatus 300b are the same as those of the same names of the analysis apparatus 300 of the second example embodiment, the descriptions thereof are omitted here.

As illustrated in FIG. 8C, the analysis evaluation support apparatus 200b of the present example embodiment is further provided with a third evaluation value calculation part 260, in addition to the configuration of the second example embodiment. The third evaluation value calculation part 260 calculates the average processing time per execution for each analysis function as the third evaluation value. The third evaluation value calculation part 260 stores the third evaluation value calculated in the evaluation value storage part 250.

In the present example embodiment, the third evaluation value calculation part 260 calculates the average processing time for each analysis function as the third evaluation value. The average processing time for each analysis function is calculated on a basis of a processing time stored in the processing time storage part 360.

For example, if a cumulative value is stored as the processing time, the third evaluation value calculation part 260 divides the processing time by the number of times used to calculate the average processing time. On the other hand, if an individual value is stored as the processing time, the third evaluation value calculation part 260 adds up all processing times for each analysis function and divides the total processing time by the number of data or the number of times used to calculate the average processing time.

Since the other functional parts are the same as those of the same names of the analysis evaluation support apparatus 200a of the second example embodiment, the descriptions thereof are omitted here. Note that the output part 230 uses the third evaluation value to generate and outputs the support data, in addition to the first evaluation value, the second evaluation value, and the overall evaluation value. The output part 230 may also generate, for example, the output screen 231 to output the support data in the present example embodiment.

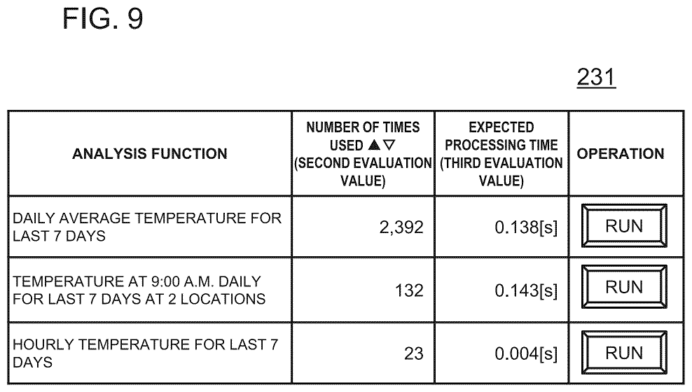

FIG. 9 illustrates an example of the output screen 231 generated by the output part 230 for a person who uses an analysis function of the present example embodiment. This output screen 231 illustrates here is an example that includes a reception interface that accepts an instruction from the person who uses thereof for executing each analysis function. Since the average processing time per execution can be considered an expected processing time, it is displayed under the name “expected processing time” for the convenience of the person.

### Analysis Evaluation Support Process

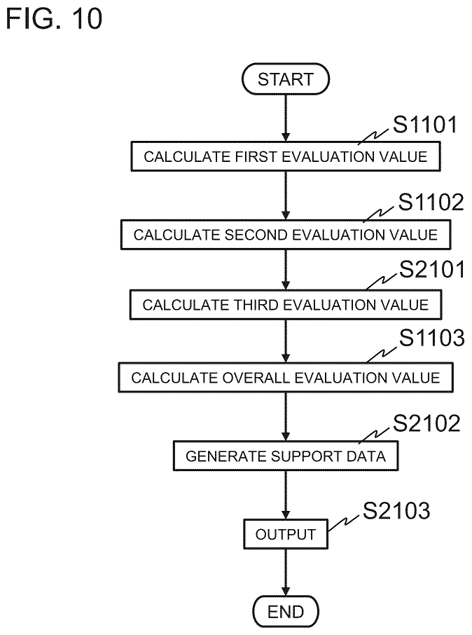

The following describes a flow of the analysis evaluation support process executed by the analysis evaluation support apparatus 200b of the present example embodiment. FIG. 10 is the processing flow of the analysis evaluation support process of the present example embodiment. It is basically the same as the analysis evaluation support process of the second example embodiment. However, the third evaluation value is calculated before the output information generation process. Only processes that differs from the analysis evaluation support process of the second example embodiment will be described below.

Here, as an example, a case is described in which the third evaluation value calculation part 260 calculates the third evaluation value after the calculation of the second evaluation value and before the calculation of the overall evaluation value. That is, after the second evaluation value calculation part 220 calculates the second evaluation value, the third evaluation value calculation part 260 receives the processing time from the analysis apparatus 300 and calculates the third evaluation value (step S2101).

Then, after the overall evaluation value calculation part 240 calculates the overall evaluation value, the output part 230 uses at least one of the first evaluation value, the second evaluation value, the third evaluation value, and the overall evaluation value to generate the support data (step S2102).

The output part 230 outputs the support data generated (step S2103) and terminates the process.

Note that either the overall evaluation value calculation process or the third evaluation value calculation process may be executed first. The data used as the basis for calculation of the evaluation value is received by each calculation part when each evaluation value calculates thereof. However, it may be transmitted in advance from the analysis apparatus 300b to the analysis evaluation support apparatus 200b at a predetermined timing and stored in the analysis evaluation support apparatus 200b.

According to the present example embodiment, the same effects as those of the first example embodiment can be obtained since it has the same configuration as the first example embodiment. In the present example embodiment, the third evaluation value is further calculated and outputted. Therefore, the user can obtain even more multifaceted evaluation value according to the present example embodiment.

It should be noted that the overall evaluation value may be calculated by taking into account not only the first evaluation value and the second evaluation value, but also a third evaluation value in the present example embodiment.

### Fourth Example Embodiment

Next, a fourth example embodiment of the present invention will be described. In the present example embodiment, a proposal is created on the basis of each evaluation value. The proposal is created as a policy for each condition and registered in advance. The condition is made on a basis of a combination of the evaluation values. The condition may be made for a combination of at least two of the first evaluation value, the second evaluation value, the third evaluation value, and the overall evaluation value.

The following is an explanation of the present example embodiment, using a case where the policy is created with a combination of the third evaluation value (processing time) and the overall evaluation value as an example.

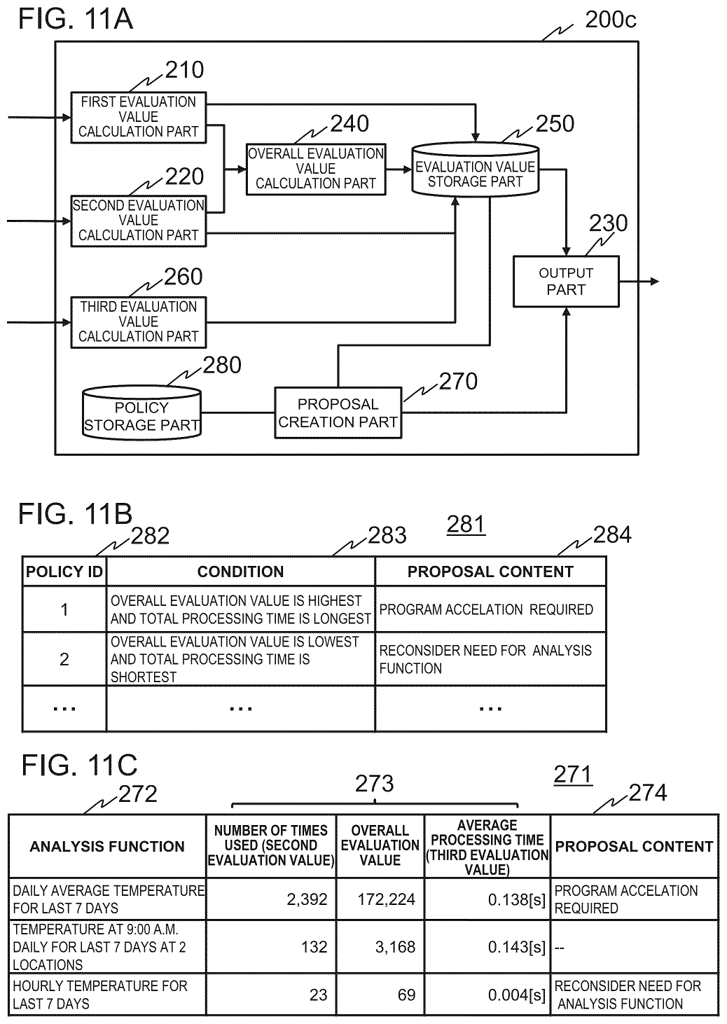

FIG. 11A illustrates a functional configuration of an analysis evaluation support apparatus 200c of the present example embodiment. The analysis evaluation support apparatus 200c has basically the same configuration as any of the analysis evaluation support apparatuses 200, 200a, and 200b. The analysis evaluation support apparatus 200c is further provided with a proposal creation part 270 and a policy storage part 280.

The policy storage part 280 stores a “proposal content” for each “condition” identified by each combination of evaluation values as a proposal policy 281. Each proposal policy 281 is created and registered in advance. FIG. 11B illustrates concrete examples of the proposal policies 281.

As illustrated in the drawing, the proposal policy 281 is provided with a policy ID 282, a condition 283, and a proposal content 284. The policy ID 282 is identification information that uniquely identifies each policy. The condition 283 is specified with a combination of at least two evaluation values. The proposal content 284 is created in advance, for example, by a developer or other specialized technical expert who is familiar with data analysis.

For example, in the example of the drawing, the condition 283 is specified with a combination of the overall evaluation value, the processing time (the third evaluation value), and the number of times used (the second evaluation value). For example, the condition 283 of a proposal policy having the policy ID 282 of 1 is “overall evaluation value is the highest and total processing time is the longest (the third evaluation value×the second evaluation value).” For the analysis function that satisfies this condition 283, “require program acceleration (program acceleration required)” is registered as the proposal content 284. Further, the condition 283 of a proposal policy having the policy ID 282 of 2 is “overall evaluation value is the lowest and total processing time is shortest (the third evaluation value×the second evaluation value).” For this condition 283, “reconsider need for analysis function” is registered as the proposal content 284.

For every possible combination of evaluation values (condition 283), a respective proposal content 284 may be registered in the proposal policy 281. Alternatively, only combinations (the conditions 283) having the proposal content 284 may be registered.

The proposal creation part 270 creates a proposal on the basis of the evaluation values of each analysis function stored in the evaluation value storage part 250 and the proposal policy 281 stored in the policy storage part 280 and outputs the created proposal from the output part 230. That is, for each analysis function, if there is a proposal policy whose combination of evaluation values stored in the evaluation value storage part 250 matches the condition 283, the proposal creation part 270 extracts the proposal content 284 thereof and makes it a proposal. Note that the proposal creation part 270 does not create proposal for an analysis function whose evaluation values do not meet the condition 283.

FIG. 11C illustrates an example of an output screen 271 in this case. This is an example of the output screen 271 for a developer, for example. For each analysis function 272, evaluation values 273 used as the basis for the proposal (the number of times used (the second evaluation value), the processing time (the third evaluation value), and the overall evaluation value), and a proposal content 274 are displayed.

The proposal can be created at any predetermined timing. For example, it may be created upon receiving a n instruction from a person who uses an analysis function or a developer. It can also be created each time a new evaluation value is registered in the evaluation value storage part 250. Alternatively, it may be created when the evaluation value registered in the condition 283 is updated.

Further, since the system configuration of the analysis function evaluation system 100, the analysis apparatus 300, and the other configurations of the analysis evaluation support apparatus 200c of the present example embodiment are the same as the configurations of the same names in the other example embodiments, the descriptions thereof are omitted.

As described above, according to the present example embodiment, any of the effects of the example embodiments above can be obtained. Further, according to the present example embodiment, an optimal proposal registered in advance for a combination of a plurality of evaluation values can be automatically outputted for each analysis function. Therefore, for example, even an inexperienced developer can obtain an optimal development policy. In other words, stable evaluation values and proposals based thereon can be outputted at all times without variation depending on the level of the developer. This means that even an inexperienced developer, for example, can proceed with future development in accordance with an appropriate policy, which can lead to the next development. In addition, by showing the proposal presented for developers to a person who uses an analysis function, for example, developers can easily convince the person of the need for development.

According to the present example embodiment, the condition 283 is created with a combination of the overall evaluation value and the third evaluation value, as an example. However, it is not limited thereto. For example, all possible combinations may be used for the condition 283, such as a combination of the first evaluation value and the second evaluation value, or a combination of the first evaluation value, the second evaluation value, and the third evaluation value. Moreover, according to the present example embodiment, the condition is defined as the evaluation value being the maximum, minimum, etc. However, for example, a threshold value may be set, and the condition may be defined as the evaluated value being above or below the threshold value, etc. Additionally, the proposal content 284 (policy) may be registered for a case where all the combinations of the evaluation values do not match any of the conditions 283. In this case, the proposal content 284 registered states, for example, “Maintain the status quo.” This will provide some sort of proposal for all analysis functions.

The analysis evaluation support apparatus 200c may not have a functional part that calculates an evaluation value not used in the condition 283. For example, if the condition 283 only uses combinations of the first evaluation value and the second evaluation value, the overall evaluation value calculation part 240 and the third evaluation value calculation part 260 need not be provided.

### Fifth Example Embodiment

Next, a fifth example embodiment of the present invention will be described. In the present example embodiment, the evaluation values are calculated for each analysis apparatus. Each analysis apparatus may be located at a single site or may be located at different sites. The present example embodiment is described below using an example in which each analysis apparatus is located at different sites.

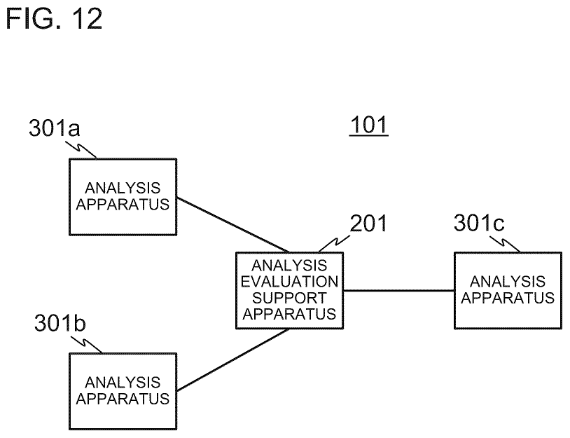

FIG. 12 is an entire configuration diagram of an analysis function evaluation system 101 of the present example embodiment. The analysis function evaluation system 101 of the present example embodiment is provided with an analysis apparatus 301a, an analysis apparatus 301b, an analysis apparatus 301c, and an analysis evaluation support apparatus 201. The explanation here is based on a case where there are three analysis apparatuses as an example, however, the number of the analysis apparatuses is not limited thereto, as long as there are at least two. If there is no need to specifically distinguish between each analysis apparatuses 301a, 301b, and 301c, they are represented by the analysis apparatus 301.

The following is an explanation using a case where the analysis apparatuses 301a, 301b, and 301c are located at sites A, B, and C, respectively as an example.

The analysis evaluation support apparatus 201 of the present example embodiment has the same configuration as that of any of the analysis evaluation support apparatuses 200, 200a, 200b, and 200c of the example embodiments described above. The following is an explanation using a case where the analysis evaluation support apparatus 201 has the same configuration as that of the analysis evaluation support apparatus 200c of the fourth example embodiment.

The processing of each functional part is basically the same as that of the functional part of the same name in the analysis evaluation support apparatus 200c. In the present example embodiment, however, the second evaluation value calculation part 220, the overall evaluation value calculation part 240, and the third evaluation value calculation part 260 calculate an evaluation value of each analysis function for each of the analysis apparatuses 301a, 301b, and 301c.

The first evaluation value (degree of reduction) does not need to be calculated for each analysis site, since it is the same for all sites as long as the analysis function is the same. On the other hand, the third evaluation value (processing time) varies depending on the specifications of the information processing apparatus (computer) that makes up the analysis apparatus 301. For example, the processing speed is affected by the type of the CPU, or whether the storage device is an HDD or an SSD. Therefore, the third evaluation value is calculated for each analysis apparatus 301.

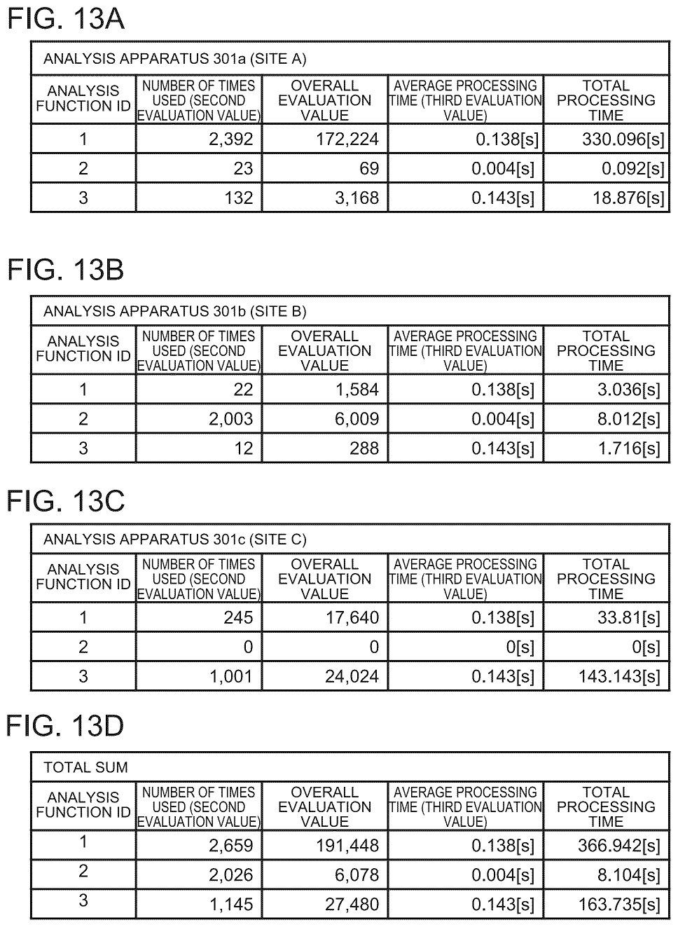

FIGS. 13A to 13C illustrate examples of the evaluation values (calculation results) calculated by the second evaluation value calculation part 220, the overall evaluation value calculation part 240, and the third evaluation value calculation part 260 and stored in the evaluation value storage part 250. As illustrated in the drawing, the second evaluation value, the overall evaluation value, and the third evaluation value are calculated for each analysis apparatus 301 and stored in the evaluation value storage part 250. As described later, if the total processing time is included in the condition 283, the total processing time may further be calculated and stored in the evaluation value storage part 250. As illustrated in FIG. 13D, the second evaluation value calculation part 220, the overall evaluation value calculation part 240, and the third evaluation value calculation part 260 may further calculate the sums (total sums) of the second evaluation values, the overall evaluation values, and the third evaluation values (plus the total processing times), respectively, for each analysis function for all the analysis apparatuses 301.

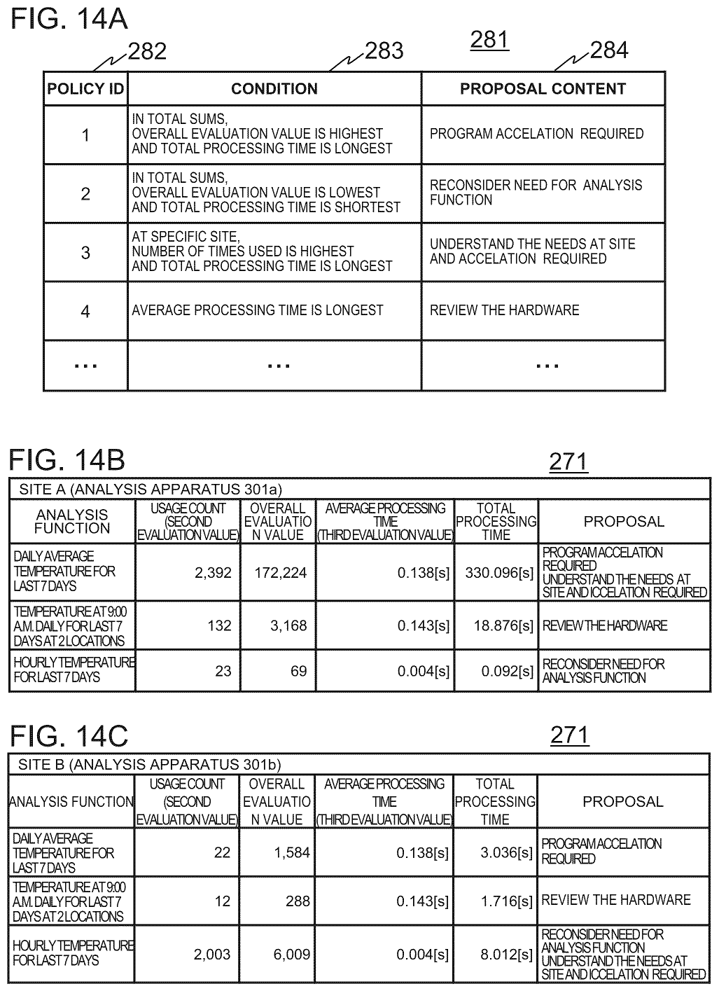

FIG. 14A illustrates examples of the proposal policies 281 stored in the policy storage part 280 of the present example embodiment. The condition 283 of a proposal policy having the policy ID 282 of 1 is “in total sums, overall evaluation value is the highest and the total processing time is the longest (the second evaluation value×the third evaluation value)” and the proposal content 284 is “program acceleration required.” The condition 283 of a proposal policy having the policy ID 282 of 2 is “in total sums, overall evaluation value is the lowest and the total processing time is the shortest” and the proposal content 284 is “reconsider need for analysis function.” The condition 283 of a proposal policy having the policy ID 282 of 3 is “at a specific site, the number of times used is the highest and the total processing time is the longest” and the proposal content 284 is “understand needs at the site, and acceleration required.”

The proposal creation part 270 selects a proposal policy whose evaluation value stored in the evaluation value storage part 250 matches the condition 283 for each analysis apparatus 301 and outputs the proposal content 284 thereof. FIGS. 14B and 14C illustrate examples of the output screens 271 (the analysis apparatus 301a and the analysis apparatus 301b).

Since the configuration of each analysis apparatus 301 of the present example embodiment and the other configurations of the analysis evaluation support apparatus 201 are the same as those having the same names in the other example embodiments, the descriptions thereof are omitted.

As described above, according to the present example embodiment, the same effects as those of the fourth example embodiment can be obtained.

According to the present example embodiment. the evaluation values are calculated for each analysis apparatus 301. For example, if there is a bias in the use of analysis functions at each site where the analysis apparatus 301 is installed, it is possible to make a proposal according to the use at each site, according to the present example embodiment. Concretely, optimal proposals can be made for different types of sites such as factories, headquarters, and sales offices. Further, it is possible to make an improvement proposal according to the performance of the analysis apparatus 301 itself. For example, a proposal may include an improvement to the hardware of the analysis apparatus 301.

In the present example embodiment described above, the analysis evaluation support apparatus 201 is described using a case in which it has the same configuration as that of the analysis evaluation support apparatus 200c, as an example. However, it is not limited thereto. For example, it may have the same configuration as any of the analysis evaluation support apparatuses 200, 200a, and 200b. In this case, the analysis evaluation support apparatus 201 calculates the evaluation values calculated by each of the analysis evaluation support apparatuses 200, 200a, and 200b, except the first evaluation value, for each analysis apparatus 301 and outputs the results.

### Hardware Configuration

The analysis evaluation support apparatuses 200, 200a, 200b, 200c, and 201 (hereinafter represented by the analysis evaluation support apparatus 200) of each of the example embodiments described above are realized by, for example, a general-purpose information processing apparatus.

For example, the general-purpose information processing apparatus is provided with a CPU (Central Processing Unit) 291, a main storage device (memory) 292, an auxiliary storage device 293, an input/output interface 294, and an expansion interface 295, which are connected to each other by an internal bus, as illustrated in FIG. 1B.

The CPU 291 achieves each of the functions described above by, for example, loading a program stored in the auxiliary storage device 293 into the main storage device 292 and executing the program, and comprehensively controls the entire analysis evaluation support apparatus 200. One or more processors such as an MPU (Micro Processing Unit) may be used instead of the CPU 291.

The main storage device 292 is a memory such as a RAM (Random Access Memory). The main storage device 292 is a work area in which the CPU 291 processes the programs or the like executed by the analysis evaluation support apparatus 200.

The auxiliary storage device 293 is, for example, a ROM (Read-Only Memory), an HDD (Hard Disk Drive), an SSD (Solid State Drive) and the like. The auxiliary storage device 293 stores various programs executed by the analysis evaluation support apparatus 200. The auxiliary storage device 293 may include a storage medium such as a flexible disk, a hard disk, an optical disk, a CD-ROM, a CD-R, a magnetic tape, a nonvolatile memory card, or a DVD.

The program stored in the auxiliary storage device 293 may be provided as a program product recorded on a non-transitory computer-readable storage medium. The auxiliary storage device 293 can be used for the medium to long-term storage of various programs recorded on the non-transitory computer-readable storage medium.

The input/output interface 294 is an interface for a wired or wireless signal and data input and output. The analysis evaluation support apparatus 200 receives information (data) required for processing from the analysis apparatus 300 via the input/output interface 294. The output part 230 outputs information via the input/output interface 294.

The expansion interface 295 is an interface to which a display device, an input device or the like is connected. The display device is, for example, a liquid crystal display monitor. The input device is a device that receives a user operation such as a keyboard or a mouse. In the example embodiments described above, via the input device, for example, the registration of a proposal policy may be accepted.

The CPU 291 achieves each function of the analysis evaluation support apparatus 200 described above by loading the program stored in the auxiliary storage device 293 into the main storage device 292 and executing the program.

The data used for processing by the analysis evaluation support apparatus 200 may be stored in the auxiliary storage device 293 in advance. The data generated during the processing is stored in the main storage device 292 or the auxiliary storage device 293. In each of the example embodiment above, for example, the evaluation value storage part 250 is structured in the auxiliary storage device 293.

It should be noted that the hardware configuration of the analysis evaluation support apparatus 200 is not limited thereto. It may include hardware not shown in the drawing.

The program that implements each function of the analysis evaluation support apparatus 200 of the present example embodiment can be recorded on a computer-readable storage medium. The storage medium may be a non-transitory one such as a semiconductor memory, a hard disk, a magnetic recording medium, an optical recording medium, and the like. The present invention can also be realized as a computer program product.

Each function of the analysis evaluation support apparatus 200 may also be implemented using, for example, an integrated circuit (IC) dedicated for each process, an application-specific integrated circuit (ASIC), a system-on-chip (SOC), a field-programmable gate array (FPGA), and the like.

The analysis apparatuses 300, 300b, and 301 (hereinafter represented by the analysis apparatus 300) of each of the example embodiments described above may also be configured with a general-purpose information processing apparatus as the analysis evaluation support apparatus 200. The hardware configuration in this case is the same as that of the analysis evaluation support apparatus 200 illustrated in FIG. 1B. Further, each function of the analysis apparatus 300 may also be implemented using, for example, an integrated circuit (IC) dedicated for each process, an application-specific integrated circuit (ASIC), a system-on-chip (SOC), a field-programmable gate array (FPGA), and the like.

### Variation 1

In each of the example embodiments described above, the first evaluation value is calculated by dividing the number of pre-analysis items by the number of the post-analysis items, however, the method for calculating the first evaluation value is not limited thereto. Any calculation method may be used as long as the first evaluation value increases as the degree of reduction rises. For example, the logarithm of the division value can also be used as the first evaluation value.

The method of calculating the overall evaluation value is also not limited to a simple multiplication of the first evaluation value and the second evaluation value. Any calculation method may be used as long as the user is able to obtain information that allows him or her to understand the evaluation of each analysis function.

In each of the example embodiments described above, the case in which the number of times an analysis function is used as the second evaluation value, which is a subjective evaluation value of a person who uses thereof, is used as an example. However, the second evaluation value is not limited thereto. For example, it may be also used the number of times the analysis result has been viewed. It may also be configured to allow the person who uses thereof to enter an evaluation value for an analysis function and use the evaluation value. The evaluation value in this case should be a simple one that is not burdensome to the person, for example, a 5-point rating.

### Variation 2

In each of the example embodiments described above, the analysis function list 321 is described using the case where the analysis apparatus 300 side holds as an example, however, it is not limited thereto. For example, the analysis evaluation support apparatus 200 side may also hold the list. In this case, the analysis function list 321 in the analysis evaluation support apparatus 200 side is also changed synchronously whenever an analysis function is added, deleted, or otherwise changed.

### Variation 3

In each of the example embodiments described above, the case in which the support data is displayed on a display of any one of the apparatuses is used as an example, however, it is not limited thereto. For example, the support data may be transmitted as data to an external apparatus.

In a plurality of flowcharts used in the above description, a plurality of steps (processes) is described in sequential order, but the order of performing of the steps performed in each example embodiment is not limited to the described order. In each example embodiment, the illustrated order of processes can be changed as long as there is no problem with regard to processing contents, such as a change in which respective processes are executed in parallel, for example.

A program stored in the auxiliary storage device 293 may be provided as a program product recorded on a non-transitory computer-readable storage medium. These can be used for the medium to long-term storage of various programs recorded on the non-transitory computer-readable storage medium.

Although the present invention has been described with reference to the example embodiments and variations, the present invention is not limited to the above-described example embodiments. Various modifications that can be understood by those skilled in the art can be made to the configurations and details of the present invention within the scope of the present invention. Further, each example embodiment and each variation can be appropriately combined with other example embodiments. In addition, for example, the network configuration and the configuration of each element illustrated in each drawing are examples to facilitate understanding of the present invention and are not limited to the configurations illustrated in the drawings.

Finally, preferred modes of the present disclosure will be summarized. The above example embodiments of the disclosure can partially or entirely be described as following Supplementary notes (Notes), though not limited thereto.

### Note 1

An analysis evaluation support apparatus includes:
a first evaluation value calculation part that calculates a first evaluation value on a basis of a change in an amount of analysis target data caused by an analysis function;
a second evaluation value calculation part that calculates a second evaluation value that represents an evaluation of the analysis function by a person who uses the analysis function; and
an output part that outputs support data obtained from at least one of the first evaluation value and the second evaluation value.

### Note 2

In the analysis evaluation support apparatus described in Note 1,
it is preferable that he first evaluation value indicates a degree of reduction in the amount of data by the analysis function.

### Note 3

In the analysis evaluation support apparatus described in Note 1 or 2,
it is preferable that the second evaluation value is at least one of the number of times the analysis function is used, the number of times an analysis result produced by the analysis function is viewed, and an evaluation value entered by a user who used the analysis function.

### Note 4

It is preferable that the analysis evaluation support apparatus described in any one of Notes 1 to 3 is further provided with an overall evaluation value calculation part that calculates an overall evaluation value using the first and the second evaluation values. It is preferable that the support data includes information obtained from the overall evaluation value.

### Note 5

It is preferable that the analysis evaluation support apparatus described in any one of Notes 1 to 4 is further provided with a third evaluation value calculation part that calculates processing time per execution of the analysis function as a third evaluation value. It is preferable that the support data further includes information obtained from the third evaluation value.

### Note 6

It is preferable that the analysis evaluation support apparatus described in any one of Notes 1 to 5 is further provided with a proposal creation part that creates a proposal for the analysis function on the basis of the first and the second evaluation values. It is preferable that the support data includes the proposal.

### Note 7

In the analysis evaluation support apparatus described in any one of Notes 1 to 6, it is preferable that the output part generates an output screen from the support data and outputs the output screen to a display device.

### Note 8

In the analysis evaluation support apparatus described in any one of Notes 1 to 7, it is preferable that the analysis function is executed on two or more analysis apparatuses, and
the first evaluation value calculation part and the second evaluation value calculation part calculate the first evaluation value and the second evaluation value, respectively, for each of the analysis apparatuses.

### Note 9

An analysis evaluation support method executed by a computer of an analysis evaluation support apparatus, the analysis evaluation support method includes:
calculating a first evaluation value on a basis of a change in an amount of processing target data caused by an analysis function;
calculating a second evaluation value representing an evaluation of the analysis function by a person who uses the analysis function; and
outputting support data obtained from at least one of the first evaluation value and the second evaluation value.

### Note 10

A program causing a computer of an analysis evaluation support apparatus to execute:
processing of calculating a first evaluation value on a basis of a change in an amount of processing target data caused by an analysis function;
processing of calculating a second evaluation value representing an evaluation of the analysis function by a person who uses the analysis function; and
processing of outputting support data obtained from at least one of the first evaluation value and the second evaluation value.

Further, as the mode of Note 1, each mode of Notes 9 and 10 can be expanded into the modes of Notes 2 to 8.

Further, the disclosure of Patent Literature cited above is incorporated herein in its entirety by reference thereto. It is to be noted that it is possible to modify or adjust the example embodiments or variations within the scope of the whole disclosure of the present invention (including the Claims) and based on the basic technical concept thereof. Further, it is possible to variously combine or select a wide variety of the disclosed elements (including the individual elements of the individual claims, the individual elements of the individual example embodiments or variations, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical values or ranges disclosed herein should be interpreted that any intermediate values or subranges falling within the disclosed ranges are also disclosed even without specific recital thereof.

### REFERENCE SIGNS LIST

100: analysis function evaluation system,
100b: analysis function evaluation system,
101: analysis function evaluation system,
200: analysis evaluation support apparatus,
200a: analysis evaluation support apparatus,
200b: analysis evaluation support apparatus,
200c: analysis evaluation support apparatus,
201: analysis evaluation support apparatus,
210: first evaluation value calculation part,
220: second evaluation value calculation part,
230: output part,
231: output screen,
240: overall evaluation value calculation part,
250: evaluation value storage part,
260: third evaluation value calculation part,
270: proposal creation part,
271: output screen,
272: analysis function,
273: evaluation value,
274: proposal content,
280: policy storage part,
281: proposal policy,
282: policy ID,
283: condition,
284: proposal content,
291: CPU,
292: primary storage device,
293: auxiliary storage device,
294: input/output interface,
295: expansion interface,
300: analysis apparatus,
300b: analysis apparatus,
301: analysis apparatus,
301a: analysis apparatus,
301b: analysis apparatus,
301c: analysis apparatus,
310: analysis target data storage part,
311: analysis target data,
312: attribute information,
313: data,
320: analysis function list storage part,
321: analysis function list,
322: analysis function ID,
323: title,
324: analysis method,
330: analysis part,
340: transmission part,
350: usage count storage part,
360: processing time storage part

What is claimed is:

1. A n analysis evaluation support apparatus, comprising:
at least a processor, and
a memory in circuit communication with the processor,
wherein the processor is configured to execute program instructions stored in the memory to implement:
a first evaluation value calculation part that calculates a first evaluation value on a basis of a change in an amount of analysis target data caused by an analysis function;
a second evaluation value calculation part that calculates a second evaluation value that represents an evaluation of the analysis function by a person who uses the analysis function; and
an output part that outputs support data obtained from at least one of the first evaluation value and the second evaluation value.

2. The analysis evaluation support apparatus according to claim 1, wherein
the first evaluation value indicates a degree of reduction in the amount of data by the analysis function.

3. The analysis evaluation support apparatus according to claim 1, wherein
the second evaluation value is at least one of the number of times the analysis function is used, the number of times an analysis result produced by the analysis function is viewed, and an evaluation value entered by the person who uses the analysis function.

4. The analysis evaluation support apparatus according to claim 1, wherein the processor is configured to execute program instructions stored in the memory to further implement:
an overall evaluation value calculation part that calculates an overall evaluation value using the first and the second evaluation values, wherein
the support data includes information obtained from the overall evaluation value.

5. The analysis evaluation support apparatus according to claim 1, wherein the processor is configured to execute program instructions stored in the memory to further implement:
a third evaluation value calculation part that calculates processing time per execution of the analysis function as a third evaluation value, wherein
the support data further includes information obtained from the third evaluation value.

6. The analysis evaluation support apparatus according to claim 1, wherein the processor is configured to execute program instructions stored in the memory to further implement:
a proposal creation part that creates a proposal for the analysis function on the basis of the first and the second evaluation values, wherein
the support data includes the proposal.

7. The analysis evaluation support apparatus according to claim 1, wherein
the output part generates an output screen from the support data and outputs the output screen to a display device.

8. The analysis evaluation support apparatus according to claim 1, wherein
the analysis function is executed on two or more analysis apparatuses, and
the first evaluation value calculation part and the second evaluation value calculation part calculate the first evaluation value and the second evaluation value, respectively, for each of the analysis apparatuses.

9. An analysis evaluation support method executed by a computer of an analysis evaluation support apparatus, the analysis evaluation support method comprising:
calculating a first evaluation value on a basis of a change in an amount of processing target data caused by an analysis function;
calculating a second evaluation value representing an evaluation of the analysis function by a person who uses the analysis function; and
outputting support data obtained from at least one of the first evaluation value and the second evaluation value.

10. A non-transitory computer-readable medium storing a program causing a computer of an analysis evaluation support apparatus to execute:
processing of calculating a first evaluation value on a basis of a change in an amount of processing target data caused by an analysis function;
processing of calculating a second evaluation value representing an evaluation of the analysis function by a person who uses the analysis function; and
processing of outputting support data obtained from at least one of the first evaluation value and the second evaluation value.

11. The analysis evaluation support method according to claim 9, wherein
the first evaluation value indicates a degree of reduction in the amount of data by the analysis function.

12. The analysis evaluation support method according to claim 9, wherein
the second evaluation value is at least one of the number of times the analysis function is used, the number of times an analysis result produced by the analysis function is viewed, and an evaluation value entered by the person who uses the analysis function.

13. The analysis evaluation support method according to claim 9, further comprising:
calculating an overall evaluation value using the first and the second evaluation values, wherein
the support data includes information obtained from the overall evaluation value.

14. The analysis evaluation support method according to claim 9, further comprising:
calculating processing time per execution of the analysis function as a third evaluation value, wherein
the support data further includes information obtained from the third evaluation value.

15. The analysis evaluation support method according to claim 9, further comprising:
creating a proposal for the analysis function on the basis of the first and the second evaluation values, wherein
the support data includes the proposal.

16. The analysis evaluation support method according to claim 9, further comprising;
generating an output screen from the support data, and
outputting the output screen to a display device.

17. The analysis evaluation support method according to claim 9, wherein
the analysis function is executed on two or more analysis apparatuses, and
the first evaluation value and the second evaluation value are calculated, respectively, for each of the analysis apparatuses.

18. The non-transitory computer-readable medium according to claim 10, wherein
the first evaluation value indicates a degree of reduction in the amount of data by the analysis function.

19. The non-transitory computer-readable medium according to claim 10, wherein
the second evaluation value is at least one of the number of times the analysis function is used, the number of times an analysis result produced by the analysis function is viewed, and an evaluation value entered by the person who uses the analysis function.

20. The non-transitory computer-readable medium according to claim 10, the program stored therein causing the computer to execute further: processing of calculating an overall evaluation value using the first and the second evaluation values, wherein
the support data includes information obtained from the overall evaluation value.
